(19) United States
(12) Patent Application Publication
(10) Pub. No.: US 2014/0256905 A1
(43) Pub. Date: Sep. 11, 2014

(54) PREPARATION OF POLYAMIDES BY HYDROLYTIC POLYMERIZATION AND SUBSEQUENT DEVOLATILIZATION

(71) Applicant: BASF SE, Ludwigshafen (DE)

(72) Inventors: Silke Biedasek, Mannheim (DE); Achim Stammer, Freinsheim (DE)

(73) Assignee: BASF SE, Ludwigshafen (DE)

(21) Appl. No.: 14/199,399

(22) Filed: Mar. 6, 2014

Related U.S. Application Data
(60) Provisional application No. 61/773,850, filed on Mar. 7, 2013.

(51) Int. Cl. C08G 69/46; C08G 69/14

(52) U.S. Cl. CPC C08G 69/46; C08G 69/14
USPC 528/323

(57) ABSTRACT

The present invention relates to a process for preparing polyamides by hydrolytic polymerization, in which the polyimide is treated in a devolatilizing apparatus after the hydrolytic polymerization.

### BACKGROUND OF THE INVENTION

The present invention relates to a process for preparing polyamides by hydrolytic polymerization, in which the polyamide is treated in a devolatilizing apparatus after the hydrolytic polymerization.

### STATE OF THE ART

Polyamides are one of the polymers produced on a large scale globally and, in addition to the main fields of use in fibers, materials and films, serve for a multitude of further end uses. Among the polyamides, polyamide-6 (polycaprolactam) with a proportion of about 57% is the most commonly produced polymer. The conventional process for preparing polyamide-6 is the hydrolytic polymerization of ε-caprolactam, which is still of very great industrial significance. Conventional hydrolytic preparation processes are described, for example, in Ullmann's Encyclopedia of Industrial Chemistry, Online Edition Mar. 15, 2003, vol. 28, p. 552-553 and Kunststoffhandbuch, 3/4 Technische Thermoplaste: Polyamide [Plastics Handbook, 3/4 Industrial Thermoplastics: Polyamides], Carl Hanser Verlag, 1998, Munich, p. 42-47 and 65-70.

In the first step of the hydrolytic polymerization, a portion of the lactam used reacts through the action of water with ring opening to give the corresponding co-aminocarboxylic acid. The latter then reacts with further lactam in polyaddition and polycondensation reactions to give the corresponding polyamide. In a preferred variant, ε-caprolactam reacts through the action of water with ring opening to give aminocaproic acid and then further to give polyamide-6. The hydrolytic polymerization can be effected in one or more stages. In general, the polycondensation and polyaddition are effected in a vertical tubular reactor (VK tube). This German abbreviation “VK” stands for “vereinfacht kontinuierlich” [“simplified continuous”]. Optionally, it is possible to use a plant with a prepolymerization stage at elevated pressure. The use of such a preliminary reactor reduces the residence time required for the ring-opening reaction of the ε-caprolactam. At the end of the vertical tubular reactor (VK tube), a polyamide melt having a composition close to the chemical equilibrium and composed of polyamide, lactam monomer, oligomers and water is obtained. The content of oligomers and monomers may, for example, be 8 to 15% by weight and the viscosity number of the crude polyamide, which is directly related to the molar mass and hence the processing properties, is generally between 110 and 160 ml/g.

Many end uses, for example for production of films for packaging materials, require a lower residual monomer content in the polyamide, and so the crude polyamide, prior to the further processing thereof, is generally subjected to an at least partial removal of monomers and/or oligomers.

To reduce the content of low molecular weight components, pellets of crude polyamide particles are generally first obtained from the product of the hydrolytic polymerization and these are then extracted with an extractant, in order to remove remaining monomers and oligomers. This is frequently effected by continuous or batchwise extraction with hot water, as described, for example, in DE 25 01 348 A and DE 27 32 328A. For purification of crude polyamide-6, extraction with caprolactam-containing water (WO 99/26996 A2) or treatment in a superheated water vapor stream (EP 0 284 986 A1) is also known. For reasons of environmental protection and of economic viability, the extracted constituents, more particularly the caprolactam and the cyclic oligomers in the case of polyamide-6, are recycled into the process. The extraction is typically followed by drying of the extracted polyamide.

Many applications additionally require polyamides having relatively high molecular weights which are not achieved by the hydrolytic polymerization alone. To increase the molecular weight or the viscosity of the polyamide, a postcondensation can then be performed after the extraction and drying, the polyamide preferably being in the solid phase (solid phase condensation). For this purpose, the pellets can be heat treated at temperatures below the melting point of the polyamide, in the course of which there is continuation of the polycondensation in particular. This leads to an increase in the molecular weight and hence to an increase in the viscosity number of the polyamide. In general, the viscosity number of polyamide-6 after the extraction and postpolymerization is about 180 to 260 ml/g.

Postcondensation and drying are frequently performed in one step, as described in WO 2009/153340 A1 and DE 199 57 664 A1.

DD 2090899 describes a process for removing low molecular weight constituents from a polyamide melt by subjecting the latter to an extraction with monomeric caprolactam and then to a monomer removal operation under reduced pressure.

DD 227140 describes a process for preparing polyamide having a degree of polymerization DP>200. The process features at least 5 successive stages. At the start of each drying stage, the surface of the molten polyamide is adjusted to >4 cm²/g of polyamide and the maximum diffusion distance of the water in the melt is adjusted to <3 mm.

WO 03/040212 discloses a method for preparing polyamide-6 by hydrolytic polymerization of ε-caprolactam under the action of water. The dewatering is achieved by the increase in the surface area of the melt.

EP 0 141 314 A2 describes a process for preparing dry polyaminecaprolactam pellets having a content of caprolactam and oligomers thereof of 8 to 13% by weight, wherein a caprolactam melt is extruded, the extruded strands are cooled to 100 to 150° C. and left at this temperature until the polycaprolactam has substantially crystallized and pelletized immediately thereafter, and the pellets are left in an inert gas stream with exclusion of molecular oxygen at a temperature of 100 to 150° C. for a period of 1 to 4 hours and then cooled. Devolatilization of the product strands at high temperatures in the molten state is not described.

EP 0 621 304 A1 describes flame-retardant thermoplastic moulding compositions obtainable by mixing
A) 20 to 70% by weight of a magnesium hydroxide and
B) 0 to 70% by weight of customary additives and processing aids into a melt of
C) 10 to 80% by weight of a polyamide prepolymer having a viscosity number of 40 to 100 ml/g,
   followed by postcondensation in the solid phase. In examples 1 and 2, a polyamide prepolymer is fed together with magnesium hydroxide and chopped glass fibers into an extruder, melted, mixed and compounded. The product thus obtained is extracted with water and dried at 80° C. (i.e. well below the melting temperature) under reduced pressure for 12 hours. Only then is the dried product subjected to a strand pelletization.

EP 0 117 495 describes the continuous preparation of polylactams, wherein an aqueous lactam composition is heated in a prepolymerization zone to a temperature of 220 to 280° C. under a pressure of 1 to 10 bar with simultaneous evaporation of the water, prepolymer and vapor are separated continuously, and the prepolymer is passed into a polymerization zone and polymerized further at a temperature of 240 to 290° C. under elevated pressure. This document teaches that the prepolymer can be discharged from the prepolymerization zone in molten form and subjected to devolatilization to remove water. However, it is not stated that this prepolymer is in strand form. Thus, it is taught specifically at page 3 lines 22-26 of this document that the prepolymer is first treated in a vented extruder and only then is the melt which has been freed of water extruded and pelletized. According to the specific embodiment in the sole example, the prepolymer is separated in a separator into water vapor and melt, and only then discharged in the form of strands and consolidated in a water bath. The discharge in the form of strands, according to the teaching of EP 0 117 495, serves for cooling and consolidation for the subsequent pelletization step and not for devolatilization/dewatering. In summary, this document therefore does not teach shaping a polyamide prepolymer from a hydrolytic polymerization to strands in the molten state and subjecting the product strands to devolatilization at high temperatures in the molten state.

An alternative route, which is not utilized significantly on the industrial scale, for preparation of polyamides is the polycondensation of amino nitriles, for example the preparation of polyamide-6 from 6-aminocapronitrile (ACN). According to a customary procedure, this process comprises a nitrile hydrolysis and subsequent amine amidation, which are generally performed in separate reaction steps in the presence of a heterogeneous catalyst, such as TiO₂. A multistage mode of operation has been found to be practicable, since the two reaction steps have different requirements in terms of water content and completeness of the reaction. In the case of this synthesis route too, it is in many cases advantageous to subject the polymer obtained to a purification for removal of monomers/oligomers.

WO 00/47651 A1 describes a continuous process for preparing polyamides by reaction of at least one aminocarbonitrile with water.

The known processes for preparing polyamides by hydrolytic polymerization are still in need of improvement. For instance, the δ-caprolactam content at the start of postpolymerization of the crude polyamide in the solid phase is well below the equilibrium value. Thus, during the final postpolymerization, a reverse polyaddition (remonomerization) reaction can take place, such that the residual monomer content of the polyamide increases again in the last step of the preparation process. Moreover, the conventional processes feature a comparatively long residence time in the postpolymerization, which is required to obtain a polyamide with appropriately high molecular weight or viscosity number. This leads to increased production costs.

It is therefore an object of the present invention to provide an improved process for preparing polyamides by hydrolytic polymerization, in which the aforementioned disadvantages are avoided. More particularly, it is to be possible by this process to provide a product having very low residual monomer content.

It has been found that, surprisingly, this object is achieved when the reaction mixture obtained in the hydrolytic polymerization, comprising polyamide, water, unconverted monomers and oligomers, rather than being subjected to an extraction, is fed directly in strand form into a devolatilizing apparatus, at least partly removing the water present, and the mixture is then subjected to a postpolymerization in the melt in a reaction zone. This specific form of melt polymerization may specifically be followed by a further workup, for example by pelletization, extraction and/or drying, but more particularly not by any further postpolymerization in the solid phase, i.e. below the melting point of the polymer. The process according to the invention can achieve polyamides with high molecular weight and low residual monomer content with a reduced overall process duration compared to conventional processes.

### SUMMARY OF THE INVENTION

The invention therefore provides a process for preparing polyamides, in which
a) a monomer composition comprising at least one lactam or at least one aminocarbonitrile and/or oligomers of these monomers is provided,
b) the monomer composition provided in step a) is converted in a hydrolytic polymerization at elevated temperature in the presence of water to obtain a reaction product comprising polyamide, water, unconverted monomers and oligomers,
c) the reaction product obtained in step b) is shaped to one or more strands,
d) the reaction product strands obtained in step c) are fed into a devolatilizing apparatus and treated under reduced pressure and/or by contacting with an inert gas, at least partly removing the water present, and
e) the devolatilized reaction product obtained in step d) is fed into a reaction zone for postpolymerization.

A specific embodiment relates to a process for preparing polyamides, in which
a) a monomer composition comprising at least one lactam or at least one aminocarbonitrile and/or oligomers of these monomers is provided,
b) the monomer composition provided in step a) is converted in a hydrolytic polymerization at elevated temperature in the presence of water to obtain a reaction product comprising polyamide, water, unconverted monomers and oligomers,
c) the reaction product obtained in step b) is shaped in the molten state to one or more strands,

d) the reaction product strands obtained in step c), without subjecting them to prior comminution to polyamide particles or to prior extraction, are fed in molten form into a devolatilizing apparatus and treated in the melt under reduced pressure and/or by contacting with an inert gas, at least partly removing the water present, and
e) the devolatilized reaction product obtained in step d) is fed in molten form into a reaction zone and subjected to postpolymerization in the melt.

The invention further provides polyamides obtainable by the process described above and hereinafter. These polyamides feature a very low residual monomer content unachievable by processes known from the prior art.

The invention further provides for the use of polyamides obtainable by the process described above and hereinafter, especially for production of pellets, films, fibers or moldings.

### DETAILED DESCRIPTION OF THE INVENTION

In the context of the present invention, “monomer” is understood to mean a low molecular weight compound as used in the preparation of the polyamide by hydrolytic polymerization for introduction of a single repeat unit. These include the lactams and aminocarbonitriles used. These also include any comonomers used for preparation of the polyamides, such as ω-aminocarboxylic acids, ω-aminocarboxamides, aminocarboxylic salts, ω-aminocarboxylic esters, diamines and dicarboxylic acids, dicarboxylic acid/diamine salts, dinitriles and mixtures thereof.

In the context of the present invention, an oligomer is understood to mean a compound as formed in the preparation of the polyamides by reaction of at least two of the compounds which form the individual repeat units. These oligomers have a lower molecular weight than the polyamides prepared in accordance with the invention. The oligomers include cyclic and linear oligomers, specifically cyclic dimer, linear dimer, trimer, tetramer, pentamer, hexamer and heptamer. Standard processes for determining the oligomeric components of polyamides generally cover the components up to the heptamer.

The viscosity number (Staudinger function, referred to as VN or J) is defined as VN=1/c×(η−ηₛ)/ηₛ. The viscosity number is directly related to the mean molar mass of the polyamide and gives information about the processability of a polymer. The viscosity number can be determined to EN ISO 307 with an Ubbelohde viscometer.

A free-flowing reaction product is understood in the context of the invention to mean a mixture capable of flowing out of a hollow body (for example an essentially vertical reaction tube). Preferably, the reaction product is shaped to strands and fed as free-flowing reaction product strands into the devolatilizing apparatus. Preferably, the reaction product obtained in step b) in the free-flowing state has a zero viscosity of 10 to 5*10³ Pa·s at 250° C.

### Step a)

In step a) of the process according to the invention, a monomer mixture comprising at least one lactam or at least one aminocarbonitrile and/or oligomers of these monomers and possibly further components is converted under polyamide-forming reaction conditions, forming a polyamide.

According to the invention, polyamides are understood to mean homopolyamides, copolyamides and polymers comprising at least one lactam or nitrile and at least one further monomer, having a content of at least 60% by weight of polyamide base units, based on the total weight of the monomer base units in the polyamide.

Homopolyamides derive from an aminocarboxylic acid or a lactam, or from a diamine and a dicarboxylic acid, and can be described by a single repeat unit. Polyamide-6 base units can be formed, for example, from caprolactam, aminocapronitrile, aminocaproic acid or mixtures thereof. Examples of homopolyamides are nylon-6 (PA 6, polycaprolactam), nylon-7 (PA 7, polyenantholactam or polyheptanamide), nylon-10 (PA 10, polydecanamide), nylon-11 (PA 11, polyundecanolactam) and nylon-12 (PA 12, polydodecanolactam).

Copolyamides derive from several different monomers, the monomers each being joined to one another by an amide bond.

Possible copolyamide units may derive, for example, from lactams, aminocarboxylic acids, dicarboxylic acids and diamines. Preferred copolyamides are polyamides formed from caprolactam, hexamethylenediamine and adipic acid (PA 6/66). Copolyamides may comprise the polyamide units in various ratios.

Polyamide copolymers comprise, as well as the polyamide base units, further base units not joined to one another by amide bonds. The proportion of comonomers in polyamide copolymers is preferably not more than 40% by weight, more preferably not more than 20% by weight, especially not more than 10% by weight, based on the total weight of the base units of the polyamide copolymer.

The polyamides prepared by the process according to the invention are preferably selected from polyamide-6, polyamide-11, polyamide-12, and the copolyamides and polymer blends thereof. Particular preference is given to polyamide-6 and polyamide-12; polyamide-6 is especially preferred.

The monomer mixture provided in step a) preferably comprises at least one C₅- to C₁₂-lactam and/or an oligomer thereof. The lactams are especially selected from ε-caprolactam, 2-piperidone (δ-valerolactam), 2-pyrrolidone (γ-butyrolactam), capryllactam, enantholactam, lauryllactam, and the mixtures and oligomers thereof.

Particular preference is given to providing, in step a), a monomer mixture comprising ε-caprolactam, 6-aminocapronitrile and/or an oligomer thereof. More particularly, in step a), a monomer mixture comprising exclusively ε-caprolactam or exclusively 6-aminocapronitrile as a monomer component is provided.

In addition, it is also possible that, in step a), a monomer mixture comprising, in addition to at least one lactam or aminocarbonitrile and/or oligomer thereof, at least one monomer (M) copolymerizable therewith is provided.

Suitable monomers (M) are dicarboxylic acids, for example, aliphatic C₄₋₁₀-alpha,omega-dicarboxylic acids such as succinic acid, glutaric acid, adipic acid, pimelic acid, suberic acid, azelaic acid, sebacic acid and dodecanedioic acid. It is also possible to use aromatic C₈₋₂₀-dicarboxylic acids such as terephthalic acid and isophthalic acid.

As diamines suitable as monomers (M), it is possible to use α,ω-diamines having four to ten carbon atoms, such as tetramethylenediamine, pentamethylenediamine, hexamethylenediamine, heptamethylenediamine, octamethylenediamine, nonamethylenediamine and decamethylenediamine. Particular preference is given to hexamethylenediamine.

Among the salts of said dicarboxylic acids and diamines suitable as monomers (M), the salt of adipic acid and hexamethylenediamine, called AH salt, is especially preferred.

Suitable monomers (M) are also lactones. Preferred lactones are, for example, 6-caprolactone and/or γ-butyrolactone.

In the preparation of the polyamides, it is possible to use one or more chain transfer agents, for example aliphatic amines or diamines such as triacetonediamine or mono- or dicarboxylic acids such as propionic acid and acetic acid or aromatic carboxylic acids such as benzoic acid or terephthalic acid.

### Step b)

The conversion of the monomer mixture provided in step a) in a hydrolytic polymerization in step b) can be effected by standard processes known to those skilled in the art. Such a process is described, for example, in Kunststoff Handbuch, 3/4 Technische Thermoplaste Polyamide, Carl Hanser Verlag, 1998, Munich, p. 42-47 and 65-70. This disclosure is fully incorporated here by reference.

Preferably, in step b), hydrolytic polymerization is accomplished by subjecting a lactam to ring opening under the action of water. This involves, for example, at least partly cleaving the lactam to give the corresponding aminocarboxylic acid, which is then polymerized further in the subsequent step by polyaddition and polycondensation. If, in a preferred embodiment, in step a), a monomer mixture comprising caprolactam is provided, the latter is at least partly opened under the action of water to give the corresponding aminocaproic acid and then reacts with condensation and polyaddition to give polyamide-6. In an alternative version, in step b), an aminocarbonitrile, specifically 6-aminocapronitrile, is subjected to a polymerization under the action of water and optionally in the presence of a catalyst.

The conversion in step b) is preferably continuous.

Preferably, the hydrolytic polymerization in step b) is effected in the presence of 0.1 to 25% by weight of added water, more preferably of 0.5 to 20% by weight of added water, based on the total amount of monomers and oligomers used. Additional water formed in the condensation reaction is not included in this stated amount.

The hydrolytic polymerization in step b) can be effected in one or more stages (for example two stages). When the hydrolytic polymerization in step b) is performed in one stage, the starting concentration of water is preferably 0.1 to 4% by weight based on the total amount of monomers and oligomers used. When the hydrolytic polymerization in step b) is performed in two stages, the VK tube is preferably connected downstream of a preliminary pressure stage, for example a preliminary pressure reactor. In the preliminary pressure stage, the starting concentration of water is preferably 2 to 25% by weight, more preferably 3 to 20% by weight, based on the total amount of monomers and oligomers used.

In a specific version, the monomer mixture provided in step a) consists of at least one lactam and the hydrolytic polymerization in step b) is effected in the presence of 0.1 to 4% by weight of water, based on the total amount of the lactam used. The lactam is specifically ε-caprolactam.

The hydrolytic polymerization in step b) can be effected in the presence of at least one regulator, such as propionic acid. If a regulator is used in step b) and the hydrolytic polymerization is performed in two stages using a preliminary pressure stage, the regulator can be used in the preliminary pressure stage and/or in the second polymerization stage. In a specific version, the hydrolytic polymerization in step b) is not effected in the presence of a regulator.

The polyamides prepared in the process according to the invention may additionally comprise customary additives such as matting agents, e.g. titanium dioxide, nucleators, e.g. magnesium silicate, stabilizers, e.g. copper(I) halides and alkali metal halides, antioxidants, reinforcers, etc., in customary amounts. The additives are generally added before, during or after the hydrolytic polymerization (step b). Preference is given to adding the additives before the hydrolytic polymerization in step b).

The conversion in step b) can be effected in one or more stages (for example two stages). In a first embodiment, the conversion in step b) is effected in one stage. In this case, the lactam or aminocarbonitrile and any oligomers thereof are preferably reacted with water and optionally additives in a reactor.

Suitable reactors are the reactors which are known to those skilled in the art and are customary for preparation of polyamides. Preferably, the hydrolytic polymerization in step b) is effected in a polymerization tube or a bundle of polymerization tubes. Specifically, for the hydrolytic polymerization in step b), at least one VK tube is used. This German abbreviation “VK” stands for “vereinfacht kontinuierlich” (“simplified continuous”]. In a multistage version of the conversion in step b), preferably at least one of the stages is effected in a VK tube. In a two-stage version of the conversion in step b), the second stage is preferably effected in a VK tube. In a two-stage version of the conversion in step b), the first stage can be effected in a preliminary pressure reactor. In the case of use of an aminocarbonitrile, the conversion in step b) is generally effected in two or more stages, the first stage preferably being effected in a preliminary pressure reactor.

In a suitable embodiment, polyamide-6 is prepared in a multistage process, specifically a two-stage process. Caprolactam, water and optionally at least one additive, for example a chain transfer agent, are supplied to the first stage and converted to a polymer composition. This polymer composition can be transferred into the second stage under pressure or by means of a melt discharge pump. This is preferably effected by means of a melt distributor.

The hydrolytic polymerization in step b) is preferably effected at a temperature in the range from 240 to 280° C. In a multistage version of the hydrolytic polymerization in step b), the individual stages can be effected at the same or at different temperatures and pressures. In the case of performance of a polymerization stage in a tubular reactor, specifically a VK tube, the reactor may have essentially the same temperature over the entire length. Another possibility is a temperature gradient in the region of at least part of the tubular reactor. Another possibility is the performance of the hydrolytic polymerization in a tubular reactor having two or more than two reaction zones which are operated at different temperature and/or at different pressure.

When the hydrolytic polymerization in step b) is effected in one stage, the absolute pressure in the polymerization reactor is preferably within a range from about 2 to 10 bar, more preferably from 1.01 bar to 2 bar. Particular preference is given to performing the one-stage polymerization at ambient pressure.

In a preferred version, the hydrolytic polymerization in step b) is performed in two stages. The upstream connection of a pressure stage makes it possible to achieve a process acceleration, by performing the rate-determining cleavage of the lactam, specifically of caprolactam, under elevated pressure under otherwise similar conditions to those in the second reaction stage. The second stage is then preferably effected in a VK tube as described above. The absolute pressure in the first stage is preferably within a range from about 1.5 to 70 bar, more preferably within a range from 2 to 30 bar. The absolute pressure in the second stage is preferably within a range from about 0.1 to 10 bar, more preferably from 0.5 bar up to 5 bar. More particularly, the pressure in the second stage is ambient pressure.

At the exit from the VK tube, the reaction product is discharged in the form of strands. Preferably, the reaction product obtained in step b) is shaped to strands in the free-flowing state and fed in the form of free-flowing reaction product strands into the devolatilizing apparatus. More particularly, the reaction product obtained in step b) is in the molten state on exit, on strand shaping and on subsequent entry into the devolatilizing apparatus.

### Step c)

Before being fed into the devolatilizing apparatus, the reaction product obtained in step b) is shaped to one or more strands. For this purpose, apparatuses known to those skilled in the art can be used. Suitable apparatuses are, for example, perforated plates, nozzles or die plates.

Preferably, the reaction product obtained in step b) is shaped to strands in the free-flowing state and fed in the form of free-flowing reaction product strands into the devolatilizing apparatus.

The hole diameter is preferably within a range from 0.5 mm to 20 cm, more preferably 0.5 mm to 5 cm, most preferably 1 mm to 10 mm.

### Step d)

In step d) of the process according to the invention, the free-flowing polyamide obtained in step b) is fed into a devolatilizing apparatus. The free-flowing polyamide obtained in step b) is treated under reduced pressure and/or by contacting with an inert gas, at least partly removing the water present.

Preferably, the reaction product strands obtained in step c) are fed into the devolatilizing apparatus in step d) without prior comminution to polyamide particles, for example by pelletization.

Preferably, the reaction product strands obtained in step c) are fed into the devolatilizing apparatus in step d) without prior extraction.

In a specific embodiment, the reaction mixture fed into the devolatilizing apparatus is conducted through the devolatilizing apparatus through gravity alone.

In a specific embodiment, the reaction mixture fed into the devolatilizing apparatus is conducted through the devolatilizing apparatus without contact with the wall of the devolatilizing apparatus.

In a preferred variant, a hot inert gas flows through the devolatilizing apparatus. Suitable inert gases are, for example, nitrogen, CO₂, helium, neon and argon, and mixtures thereof. Preference is given to using nitrogen. The temperature of the inert gas which flows through the devolatilizing apparatus is preferably within a range from 180 to 290° C., preferably 240 to 280° C.

The devolatilizing apparatus can in principle be operated under standard pressure, elevated pressure or reduced pressure. The pressure in the devolatilizing apparatus is then preferably 1 mbar to 1.5 bar, more preferably 10 mbar to 1 bar. In a preferred variant, the devolatilizing apparatus is operated under reduced pressure. The pressure in the devolatilizing apparatus is preferably within a range from 10 mbar to 1 bar, more preferably 100 mbar to 800 mbar.

In a preferred embodiment, the devolatilizing apparatus is operated under reduced pressure and inert gas flows through simultaneously. The pressure in the devolatilizing apparatus is preferably within a range from 10 mbar to 1 bar, more preferably 100 mbar to 800 mbar. The temperature of the inert gas which flows through the devolatilizing apparatus is preferably within a range from 180 to 290° C., preferably 240 to 280° C.

Suitable devolatilizing apparatuses are strand devolatilizers, devolatilizing vessels (flash vessels), thin-film evaporators, spray driers, devolatilizing columns with internals, for example baffles, devolatilizers with miscible internals and other customary devolatilizing apparatuses. Preference is given to using strand devolatilizers.

The term “strand devolatilizer” typically refers to an essentially vertical vessel with an entry orifice for the free-flowing reaction mixture at the upper end and an exit orifice at the lower end. The term “essentially vertical” means that the strand devolatilizer need not be arranged exactly perpendicularly to the surface of the earth, but may deviate therefrom by up to 30°, preferably by up to 20°.

Preferably, the strand devolatilizer is equipped for operation under inert gas and/or reduced pressure. Additionally preferably, the strand devolatilizer is heatable, for example by means of steam, gas burners or an outer jacket containing heat carrier.

Preferably, the free-flowing reaction mixture from step b) enters the strand devolatilizer from the top through a die plate or perforated plate. This forms one or more component strands of the free-flowing reaction mixture. The reaction mixture is then conveyed through the strand devolatilizer, preferably though the effect of gravity alone.

In one possible embodiment, the devolatilizing apparatus, preferably the strand devolatilizer, may be arranged below the apparatus for hydrolytic polymerization. The conveying operation can be effected by means of gravity. Optionally, the conveying operation can be supported using one or more melt pumps.

The devolatilizing apparatuses may typically have upstream or downstream apparatus for regulation of the pressure, for example pressure-regulating valves.

The devolatilization in step d) can be effected in one stage (in a single devolatilizing apparatus). It can also be performed in more than one stage, for example in two stages, in a plurality of devolatilizing steps arranged in succession and/or in parallel. Preference is given to performing the devolatilization in one stage.

In the case of a one-stage devolatilization, the pressure in the devolatilizing apparatus is typically 1 mbar to 1.5 bar, preferably 10 mbar to 1 bar, and the temperature is generally 180 to 290° C., preferably 240 to 280° C.

In the case of multistage devolatilization, the devolatilizing apparatuses may be the same or different in terms of type and size. For example, it is possible to use two identical devolatilizing apparatuses, or two devolatilizing apparatuses of different sizes. For example, it is also possible to operate two devolatilizing apparatuses in succession, in which case each of the devolatilizing apparatuses has different pressure levels. For example, it is also possible to operate two devolatilizing apparatuses in succession, in which case each of the devolatilizing apparatuses has different inert gas flows. For example, it is also possible to operate two devolatilizing apparatuses in succession, in which case each of the devolatilizing apparatuses has different pressure levels and different inert gas flows.

In the case of a two-stage devolatilization, the pressure in the devolatilizing apparatus is typically 1 mbar to 1.5 bar, preferably 10 mbar to 1 bar, and the temperature is generally 180 to 290° C., preferably 230 to 280° C. The temperature generally differs insignificantly from the temperature in a one-stage devolatilization.

The temperature of the polyamide in the devolatilization is typically controlled by means of heat exchangers, outer jackets, temperature-controlled static mixers, internal heat exchangers or other suitable apparatuses. The setting of the devolatilization pressure is likewise undertaken in a manner known per se, for example by means of pressure-regulating valves.

A suitable parameter for characterization of the devolatilizing performance is the devolatilization number E_{z}=m/(πρDL), where m: mass flow rate of the melt, p: density of the melt, D: diffusion coefficient, L: strand length. The devolatilization number is preferably 0.1 to 20.

In the case of multistage devolatilization, these times are each based on a single stage.

The devolatilization in step c) at least partly removes the water present in the reaction mixture obtained in the hydrolytic polymerization.

Preferably, the devolatilized reaction mixture obtained in step c) has a water content of 0.03 to 0.15% by weight, based on the total weight.

As a result of the depletion of the water, the reaction mixture is no longer at the equilibrium established after the hydrolytic polymerization, and so the polycondensation can advance further. This can even be effected under the conditions existing in the devolatilizing apparatus.

It is possible that the devolatilization in step d) additionally also removes monomers and/or oligomers from the reaction product. The components present in the gaseous output from the devolatilizing apparatus can be condensed and at least partly recycled into the polymerization (step b)).

The devolatilized reaction product obtained in step d) can fully or partly be subjected again to the devolatilization in step d). Thus, a further removal of water in the recycled polymer product can be achieved.

On exit from the devolatilizing apparatus, the component strands of the reaction product can be combined again.

After the devolatilized reaction product has left the devolatilizing apparatus in step d), the reaction product is fed into a reaction zone. Preferably, the reaction product is pumped into a reaction zone in free-flowing form. For this purpose, suitable apparatuses known to those skilled in the art can be used. An example of a suitable apparatus is a melt pump.

### Step e)

In step e) of the process according to the invention, the devolatilized reaction product obtained in step d) is fed into a reaction zone for postpolymerization.

The devolatilized reaction product obtained from step d) is preferably fed into a reaction zone without prior comminution to polyamide particles.

The postpolymerization in step e) can be effected in one or more stages (for example two stages). In the postpolymerization performed in two stages in step e), the polymer obtained or some of the polymer obtained can be recycled into the postpolymerization after step e). In a preferred embodiment, the postpolymerization in step e) is effected in one stage.

The reaction zone in which the postpolymerization takes place is preferably a reactor, more preferably a tubular reactor and specifically a tubular reactor having plug flow characteristics, meaning that near plug flow conditions are achieved. The tubular reactor is characterized in that the state of the reaction mixture in the reaction, in terms of the material and physical properties (for example temperature, composition etc.), can vary in flow direction, but the state of the reaction mixture is the same for each individual unit cross section at right angles to flow direction. In the ideal case, all volume elements entering the tube have the same residence time in the reactor. Viewed pictorially, the liquid flows through the tube as if it were a series of plugs sliding easily through the tube. This means that crossmixing takes place at right angles to flow direction, i.e. mass and heat transfer in radial direction, but virtually no backmixing in flow direction, i.e. no significant mass and heat transfer in axial direction. The flows are generally turbulent and the laminar edge effects negligible. This is achieved by a tubular reactor with static mixers.

In the postpolymerization in step e), the temperature in the reaction zone is preferably within a range from 200 to 270° C., more preferably from 220 to 260° C.

The temperature of the polyamide in the postpolymerization in step e) is controlled, for example, by means of heat exchangers, such as outer jackets, internal heat exchangers or other suitable apparatuses.

The residence time in the reaction zone in step e) is preferably 30 minutes to 24 hours, more preferably 1 hour to 12 hours.

In a preferred embodiment, the residence time of the polymer in step e) is selected such that the relative viscosity of the polyamide has increased by at least 10%, preferably by at least 15%, more preferably by at least 20%, based on the relative viscosity of the polyamide prior to step d).

The relative viscosity of the polyamide is typically used as a measure for the molecular weight. The relative viscosity is determined in accordance with the invention at 25° C. as a solution in 96 percent by weight H₂SO₄ having a concentration of 1.0 g of polyamide in 100 ml of sulfuric acid. The determination of relative viscosity follows DIN EN ISO 307.

In a specific embodiment of the process according to the invention, the reaction product strands obtained in step c) are not subjected to any subsequent comminution to polyamide particles (pelletization) until completion of the postpolymerization in step e).

In a further specific embodiment of the process according to the invention, the reaction product in steps c), d) and e) is permanently in the molten state.

The postpolymerization in step e) can additionally improve the properties of the polymers. This is especially true of the establishment of the viscosity of the polymers desired for the further processing. The viscosity number of the polyamide obtained by the process according to the invention is preferably 185 to 260 ml/g.

In a specific embodiment of the process according to the invention, the polyamide obtained in step e) is subjected to a shaping operation to obtain polyamide particles, specifically to a pelletization.

A pelletization is especially appropriate if the polyamide is subsequently to be extracted. For pelletization, the polyamide can be cast in strands, solidified and then pelletized. A further process is underwater pelletization, which is known in principle to those skilled in the art.

In a specific embodiment of the process according to the invention, the polyamide obtained in step e), optionally after a pelletization, is extracted and/or dried.

Suitable processes and apparatuses for extraction of polyamide particles are known in principle to those skilled in the art.

Extraction means that the content of monomers and any dimers and further oligomers in the polyamide is reduced by treatment with an extractant. This can be accomplished industrially, for example, by continuous or batchwise extraction with hot water (DE 2501348 A, DE 2732328 A) or in a superheated water vapor stream (EP 0284968 W1).

Preference is given to extraction using an extractant comprising water or consisting of water. In a preferred version, the extractant consists solely of water. In a further preferred version, the extractant comprises water and a lactam used for preparation of the polyamide. In the case of polyamide-6, it is thus also possible to extract using caprolactam-containing water, as described in WO 99/26996 A2.

The temperature of the extractant is preferably within a range from 75 to 130° C., more preferably from 85 to 120° C.

The extraction can be effected continuously or batchwise. Preference is given to a continuous extraction.

In the extraction, the polyamide particles and the extractant can be conducted in cocurrent or in countercurrent. Preference is given to extraction in countercurrent.

In a first preferred embodiment, the polyamide particles are extracted continuously in countercurrent with water at a temperature of 5100° C. and ambient pressure. In that case, the temperature is preferably within a range from 85 to 99.9° C.

In a further preferred embodiment, the polyamide particles are extracted continuously in countercurrent with water at a temperature of 100° C. and a pressure in the range from 1 to 2 bar absolute. In that case, the temperature is preferably within a range from 101 to 120° C.

For extraction, it is possible to use customary apparatuses known to those skilled in the art. In a specific version, extraction is accomplished using at least one pulsed extraction column.

For reasons of environmental protection and of economic viability, the extracted monomers and any dimers and/or higher oligomers are preferably recovered from the extractant and reutilized. The components present in the laden extractant obtained in the extraction, selected from monomers and any dimers and/or oligomers, can be isolated for this purpose and recycled into step a) or b).

A specific version of the process according to the invention comprises the following steps:
separating the laden extractant obtained into a fraction enriched in monomers and/or oligomers and a fraction depleted of monomers and/or oligomers,
feeding at least part of the fraction enriched in monomers and/or oligomers into the monomer composition provided in step a) or the reaction zone used for hydrolytic polymerization in step b),
reusing at least some of the fraction depleted of monomers and/or oligomers as the extractant.

Preferably, the extracted polyamide is subjected to a drying operation. The drying of polyamides is known in principle to those skilled in the art. For example, the extracted pellets can be dried by contacting with dry air or a dry inert gas or a mixture thereof. Preference is given to using an inert gas, e.g. nitrogen, for drying. The extracted pellets can also be dried by contacting with superheated water vapor or a mixture thereof with a different gas, preferably an inert gas. For drying, it is possible to use customary driers, for example countercurrent driers, crosscurrent driers, pan driers, tumble driers, paddle driers, crossflow driers, cone driers, tower driers, fluidized beds, etc. A suitable version is batchwise drying in a tumble drier or cone drier under reduced pressure. A further suitable version is continuous drying in tubular driers, through which a gas which is inert under the drying conditions flows. In a specific version, drying is accomplished using at least one tower drier. Preferably, a hot inert gas which is inert under the postpolymerization conditions flows through the tower drier. A preferred inert gas is nitrogen.

It is also possible to merely dry the polyamide without prior extraction.

The polyamide obtained after extraction and drying preferably has a residual monomer content in the range of greater than 0 to 0.1% by weight. Preferably, the polyamide obtained after extraction and drying has a residual monomer content of less than 0.05% and preferably less than 0.03% by weight. Preferably, the polyamide obtained after extraction and drying has a cyclic dimer content of less than 0.1%, preferably less than 0.08% and more preferably less than 0.02% by weight.

The process according to the invention can be performed continuously or batchwise, and is preferably performed continuously.

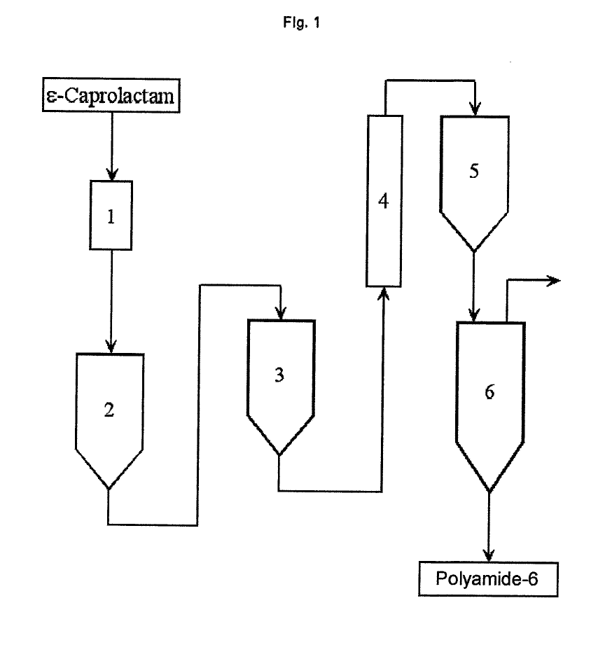

The process is illustrated in detail below by FIG. 1 and the examples.

FIG. 1 shows a schematic of one embodiment for performance of the process according to the invention.

In FIG. 1, the following reference numerals are used:
1 preliminary pressure reactor
2 VK tube
3 strand devolatilization
4 polymerization in the plug flow reactor
5 extraction
6 drying

### EXAMPLES

FIG. 1: Process according to the invention for preparation of polyamide-6 Table 1: Compilation of the results of examples 1a to 1d and for the starting sample

A melt of an industrially available polyamide-6 intermediate which has been withdrawn from the polyamide-6 production process after melt polymerization in a VK tube was converted with the aid of a die having an exit orifice of diameter 4 mm to a polymer strand, which falls at 270° C. through an 800 mm freefall zone in an opposing nitrogen flow and is collected in a vessel at a controlled temperature of 250° C. In this vessel, the melt was left under a nitrogen blanket for postpolymerization. After cooling, the polyamide block obtained was ground first in a hammer mill with dry ice cooling and then by means of an ultracentrifugal mill while cooling with liquid nitrogen. The particles now present, having diameters of 2 to 3 mm, were extracted with deionized water at 95° C. for 48 h. For the extraction, a 2 l stirred tank was initially charged with 625 g of pellets, which were extracted with a water flow of 2 l/h. 80 g of the extracted material were dried at 120° C. while passing nitrogen over at 11 l/h.

The viscosity number (VN) of the samples obtained was determined to EN ISO 307:2007 on solutions of the polyamide in 96% by weight sulfuric acid having a concentration of 1 g per 100 ml. The caprolactam content was determined by means of gas chromatography.

The experimental conditions and results are given in table 1.

TABLE 1

| | | Residence | | |
|---|---|---|---|---|
| | Melt | time in the | | |
| | strand | heated vessel | | |
| | through- | for post- | Viscosity | |
| | put | polymerization | number | Caprolactam |
| Example | [g/min] | [h] | VN | content |
| Sample | — | — | 134 | 9.92% |
| after VK | | | | |
| tube | | | | |
| 1a | 2.0 | 6 | 201 | 0.02% |
| 1b | 2.0 | 8 | 211 | 0.02% |

1-23. (canceled)

24. A process for preparing polyamides which comprises
a) providing a monomer composition comprising at least one lactam or at least one aminocarbonitrile and/or oligomers of these monomers,
b) converting the monomer composition provided in step a) in a hydrolytic polymerization at elevated temperature in the presence of water to obtain a reaction product comprising polyamide, water, unconverted monomers and oligomers,
c) shaping the reaction product obtained in step b) to one or more strands,
d) feeding the reaction product strands obtained in step c) into a devolatilizing apparatus and treated under reduced pressure and/or by contacting with an inert gas, at least partly removing the water present, and
e) feeding the devolatilized reaction product obtained in step d) into a reaction zone for postpolymerization.

25. The process according to claim 24, wherein the monomer composition provided in step a) comprises e-caprolactam or 6-aminocapronitrile and/or oligomers of these monomers.

26. The process according to claim 24, wherein the conversion in step b) is effected in two stages and an essentially vertical tubular reactor is used at least in the second stage.

27. The process according to claim 24, wherein the reaction product obtained in step b) is shaped in the free-flowing state to strands and fed into the devolatilizing apparatus as free-flowing reaction product strands.

28. The process according to claim 24, wherein the reaction product strands obtained in step c) are fed into the devolatilizing apparatus in step d) without prior comminution to polyamide particles and without prior extraction.

29. The process according to claim 24, wherein the temperature of the reaction mixture fed into the devolatilizing apparatus on entry into the devolatilizing apparatus is 180° C. to 290° C.

30. The process according to claim 24, wherein the devolatilizing apparatus used in step d) is a strand devolatilizer.

31. The process according to claim 24, wherein the treatment of the reaction mixture in the devolatilizing apparatus in step d) is effected at a temperature of 180° C. to 290° C.

32. The process according to claim 24, wherein the treatment of the reaction mixture in the devolatilizing apparatus in step d) is effected at a pressure of 1 mbar to 1.5 bar.

33. The process according to claim 24, wherein inert gas flows through the devolatilizing apparatus in step d).

34. The process according to claim 24, wherein the devolatilizing apparatus in step d) is operated under reduced pressure and inert gas flows through simultaneously.

35. The process according to claim 24, wherein postpolymerization in step e) is accomplished using a melt of the reaction product obtained in step d).

36. The process according to claim 24, wherein the reaction zone used for postpolymerization in step e) comprises a tubular reactor or consists of a tubular reactor.

37. The process according to claim 24, wherein the residence time in the reaction zone in step e) is 30 minutes to 24 hours.

38. The process according to claim 24, wherein the reaction product strands obtained in step c) are not subjected to any subsequent comminution to polyamide particles (pelletization) until completion of the postpolymerization in step e).

39. The process according to claim 24, wherein the reaction product in steps c), d) and e) is permanently in the molten state.

40. The process for preparing polyamides according to 24, in which
a) providing a monomer composition comprising at least one lactam or at least one aminocarbonitrile and/or oligomers of these monomers,
b) converting the monomer composition provided in step a) in a hydrolytic polymerization at elevated temperature in the presence of water to obtain a reaction product comprising polyamide, water, unconverted monomers and oligomers,
c) shaping the reaction product obtained in step b) in the molten state to one or more strands,
d) feeding the reaction product strands obtained in step c), without subjecting them to prior comminution to polyamide particles or to prior extraction, in molten form into a devolatilizing apparatus and treated in the melt under reduced pressure and/or by contacting with an inert gas, at least partly removing the water present, and
e) feeding the devolatilized reaction product obtained in step d) in molten form into a reaction zone and subjected to postpolymerization in the melt.

41. The process according to claim 40, wherein the polyamide obtained from step e) is subjected in an additional step 1) to a shaping operation to obtain polyamide particles.

42. The process according to claim 41, wherein the polyamide obtained in step e) or step f) is subjected in an additional step g) to a treatment with at least one extractant.

43. The process according to claim 40, wherein monomers and any oligomers isolated from the polyamide in step d) are recycled into step a) or b).

44. The process according to claim 40, which is performed continuously.

45. A polyamide obtainable by a process as defined in claim 40.

46. A process for production of pellets, films, fibers or moldings which comprises utilizing the polyamide as claimed in claim 45.
